(19) United States
(12) Patent Application Publication
(10) Pub. No.: US 2017/0227302 A1
(43) Pub. Date: Aug. 10, 2017

(54) STACKED PLATE HEAT EXCHANGER, IN PARTICULAR FOR A MOTOR VEHICLE

(71) Applicant: Mahle International GmbH, Stuttgart (DE)

(72) Inventors: Andreas Draenkow, Heimsheim (DE); Frank Janson, Muehlacker (DE); Stefan Schmidgall, Stuttgart (DE)

(21) Appl. No.: 15/424,447

(22) Filed: Feb. 3, 2017

(30) Foreign Application Priority Data
Feb. 4, 2016 (DE) 102016201712.8

(51) Int. Cl. F28F 3/08; F28D 9/00; B60R 16/08; F28F 13/12

(52) U.S. Cl. CPC F28F 3/08; F28F 13/12; F28D 9/0093; B60R 16/08

(57) ABSTRACT

A stacked-plate heat exchanger may include a plurality of stacked plates that are stacked one on top of another in a stacking direction to form a first fluid channel and a second fluid channel through which a first fluid and a second fluid are flowable. The plurality of stacked plates may be arranged in the stacking direction between a first end plate and a second end plate opposite the first end plate. The plurality of stacked plates may also include a plurality of through-openings that form distribution channels and collection channels. The heat exchanger may also include a first stacked plate arranged between the first end plate and a second stacked plate, the second stacked plate connected to the first end plate and first stacked plate by an integral connection.

### CROSS-REFERENCE TO RELATED APPLICATIONS

This application claims priority to German Patent Application No. 10 2016 201 712.8, filed Feb. 4, 2016, the contents of which are hereby incorporated by reference in its entirety.

### TECHNICAL FIELD

The invention relates to a stacked-plate heat exchanger, in particular for a motor vehicle, and to a motor vehicle having a stacked-plate heat exchanger of this type.

### BACKGROUND

Stacked-plate heat exchangers are used in many different forms in automotive engineering.

Conventional stacked-plate heat exchangers comprise a plurality of stacked plates stacked one on top of the other as standard. The stacking of these plates produces fluidically separate fluid channels for the two fluids. The stacked-plate block thus produced is typically delimited in the stacking direction of the stacked plates by a first end plate at the top and an opposite second end plate at the bottom, the latter acting as a base plate with a fastening flange for fastening the stacked-plate heat exchanger to a component of the motor vehicle.

The first end plate typically has a greater plate thickness than the individual stacked plates and a peripheral lip that stands up in the stacking direction. The stacked-plate block formed from the stacked plates is sealed fluidically with the aid of the first end plate.

If rim holes for attaching a connection piece are needed in the first end plate, it is possible that the seal between the rim hole formed in the first end plate and the adjacent, first stacked plate of the stacked-plate block no longer functions. In this case, a fluid could penetrate undesirably into the fluid channel formed between the first end plate and the first stacked plate. To prevent this, the stacked plates must be sealed by means of a leakproof soldered connection of the upright lips of the first end plate and the first stacked plate. This soldered connection is however technically relatively complex.

### SUMMARY

Against this background, an object of the present invention is to find new ways to develop stacked-plate heat exchangers with particularly low production costs.

This object is achieved by the subject matter of the independent patent claims. Preferred embodiments form the subject matter of the dependent patent claims.

The basic concept of the invention is accordingly to form a stacked-plate heat exchanger with a flat first end plate without a lip, to arrange the latter between the top end plate and the second end plate adjacent to the first end plate in the stacking direction, and to connect the two said stacked plates integrally to the first end plate. This integral connection can preferably be a soldered connection. In this manner, the necessary sealing effect between the first end plate and the first stacked plate can be achieved in a particularly simple manner in design terms without having to provide an lip on the first end plate, to be soldered to the lip of the first stacked plate. This means considerable simplifications for the production of the stacked heat exchanger, with which considerable cost savings are associated.

A stacked-plate heat exchanger according to the invention comprises a plurality of stacked plates, which are stacked one on top of the other in a stacking direction to form first and second fluid channels for first and second fluids. The stacked plates are arranged in the stacking direction between a first end plate and a second end plate opposite the first end plate. The stacked plates have through-openings for forming distribution channels and collection channels for the two fluids interacting thermally with each other. According to the invention, the first stacked plate that is adjacent to the first end plate in the stacking direction is flat, at least in the region of the through-openings of the first stacked plate. Furthermore, the first stacked plate is arranged between the end plate and the second stacked plate adjacent to the first stacked plate in the stacking direction. According to the invention, the second stacked plate is connected to the first stacked plate and the first end plate by means of an integral connection, in particular a soldered connection.

In a preferred embodiment, at least one through-opening of at least one stacked plate—with the exception of the first stacked plate—is in the form of a rim hole. This measure allows a technically simple implementation of distribution channels and collection channels for distributing the two fluids to the first and second fluid channels and collecting them from the first and second fluid channels.

The integral connection according to the invention is particularly preferably arranged in the region of the through-opening of the first end plate. In this manner, a particularly good sealing effect is achieved in the region of the rim hole.

In a further advantageous development, the stacked plates have an upright lip running at least part, preferably all, the way round said stacked plates. This allows the individual stacked plates to be fastened to each other with a soldered connection formed between the lips of adjacent stacked plates.

The first stacked plate that is adjacent to the end plate in the stacking direction is particularly preferably completely flat except for the upright lip. Particularly low production costs are associated with a first stacked plate of such simple design.

The first end plate particularly preferably does not have an upright lip as is present in the stacked plates. This means that the first end plate can be produced in a technically particularly simple manner and thus cost-effectively.

In a further preferred embodiment, the first end plate has through-openings that align with the through-openings of the first stacked plate with respect to the stacking direction.

In a further preferred embodiment, the first stacked plate bears flat against the first end plate in the region of the through-openings. This measure simplifies the application of the integral connection according to the invention for sealing the first and second stacked plates against the first end plate.

In an advantageous development, all the stacked plates including the first stacked plate have substantially the same stacked plate thickness. This measure results in a simplified manufacturing process for the stacked plates, which can at least partially be in the form of identical parts. This is associated with considerably cost advantages during manufacture.

In an advantageous development, the through-openings of the first stacked plate are not in the form of rim holes. This measure simplifies the production process of the first stacked plate.

In another preferred embodiment, at least one through-opening of the first stacked plate has a greater opening cross section in a longitudinal section in the stacking direction than the through-opening of the first end plate that is adjacent in the stacking direction.

In an alternative embodiment thereto, at least one through-opening of the first stacked plate has a smaller opening cross section in the longitudinal section in the stacking direction than the through-opening of the first end plate that is adjacent in the stacking direction.

In another preferred embodiment, at least one through-opening, which is present in the second stacked plate, is closed by the first stacked plate.

The first end plate particularly expediently has an opening collar, which surrounds a through-opening of the first end plate. Said opening collar protrudes away from the first stacked plate with respect to the stacking direction, preferably in the stacking direction. Such an opening collar allows a connection piece or the like to be attached stably to the through-opening.

In a further preferred embodiment, the stacked-plate heat exchanger has at least one connection piece, an end section of which is inserted into the through-opening provided in the first end plate. The connection piece particularly preferably terminates flush with the first end plate. This measure also facilitates stable attachment of a connection piece or the like.

In an advantageous development, the connection piece has a circumferential wall with an end opening, which communicates fluidically with the through-opening of the first end plate. An outwardly projecting bead is formed in the circumferential wall at a distance from the end opening, said bead bearing against the opening collar of the through-opening of the first end plate. A bead formed in this manner allows the connection piece to be fixed to the first end plate in a mechanically particularly stable manner.

In a further preferred embodiment, turbulence-generating elements are formed in at least one stacked plate, with the exception of the first stacked plate, for the first and/or second fluids flowing through the first and/or second fluid channels. Such turbulence-generating elements can be used to increase the heat exchange between the two fluids, which results in improved efficiency of the heat exchanger.

The turbulence-generating elements are particularly expediently in the form of fin-like structures. Turbulence-generating elements in the form of such fin structures can be formed on the stacked plates particularly simply and thus cost-effectively by means of suitable forming processes during production.

The invention also relates to a motor vehicle having a stacked-plate heat exchanger as presented above. The above-explained advantages of the stacked-plate heat exchanger therefore also apply to the motor vehicle according to the invention.

Further important features and advantages of the invention can be found in the dependent claims, the drawings and the associated description of the figures using the drawings.

It is self-evident that the above-mentioned features and those still to be explained below can be used not only in the combination given in each case but also in other combinations or alone without departing from the scope of the present invention.

Preferred exemplary embodiments of the invention are shown in the drawings and are explained in more detail in the description below, the same reference symbols referring to the same or similar or functionally equivalent components.

### BRIEF DESCRIPTION OF THE DRAWINGS

In the figures,

FIG. 1 schematically shows a stacked-plate heat exchanger according to the invention,

FIG. 2 schematically shows the stacked heat exchanger of FIG. 1 in a longitudinal section in the region of a through-opening,

FIG. 3 schematically shows a variant of the stacked heat exchanger of FIG. 1,

FIG. 4 schematically shows a further variant of the stacked heat exchanger of FIG. 1.

### DETAILED DESCRIPTION

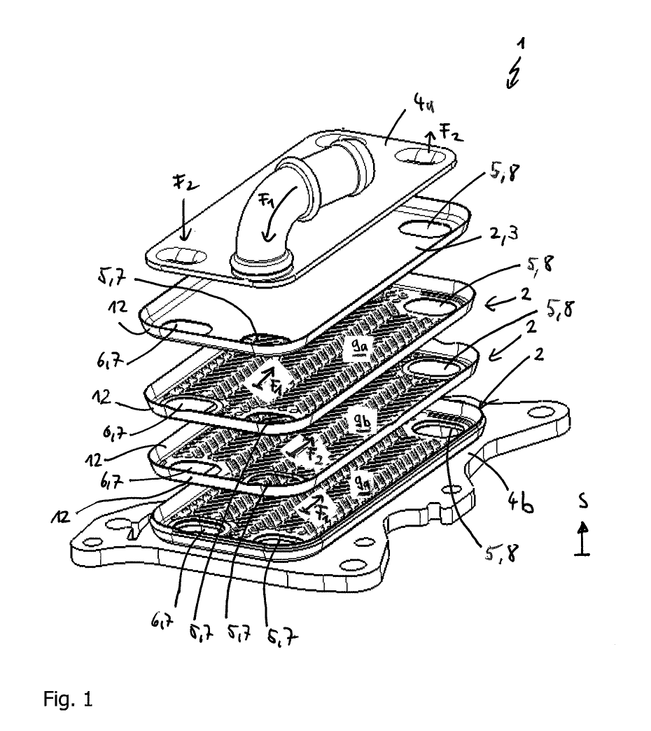

FIG. 1 shows an example of a stacked-plate heat exchanger 1 according to the invention in an exploded diagram. The stacked-plate heat exchanger 1 comprises a plurality of tray-shaped stacked plates 2, which are stacked one on top of the other in a stacking direction S to form first and second fluid channels 9a, 9b through which first and second fluids F₁, F₂ flow. Turbulence-generating elements 19 are formed in the stacked plates 2—with the exception of the first stacked plate 3—for the first and second fluids F₁, F₂ flowing through the first and second fluid channels 9a, 9b. The turbulence-generating elements 19 are implemented as fin-like structures 20 in the example of the figures.

The first stacked plate 3 is arranged between the first end plate 4a and a second stacked plate 21 adjacent to the first stacked plate 3 in the stacking direction S. The second stacked plate 21 is connected to the first stacked plate 3 and the first end plate 4a by means of an integral connection, in particular a soldered connection. The stacked plates 2 are arranged in the stacking direction S between a first end plate 4a and a second end plate 4b opposite the first end plate 4a.

As can be seen in FIG. 1, the stacked plates 2 have through-openings 5, 6 for forming distribution channels 7 and collection channels 8 for the two fluids F₁, F₂. The first stacked plate 3 adjacent to the first end plate 4a in the stacking direction S is flat, at least in the region of the through-openings 5, 6 of the first stacked plate 3. All the stacked plates 2 including the first stacked plate 3 have substantially the same stacked plate thickness d. The stacked plates 2 have an upright lip 12 running at least part, preferably all, the way round said stacked plates.

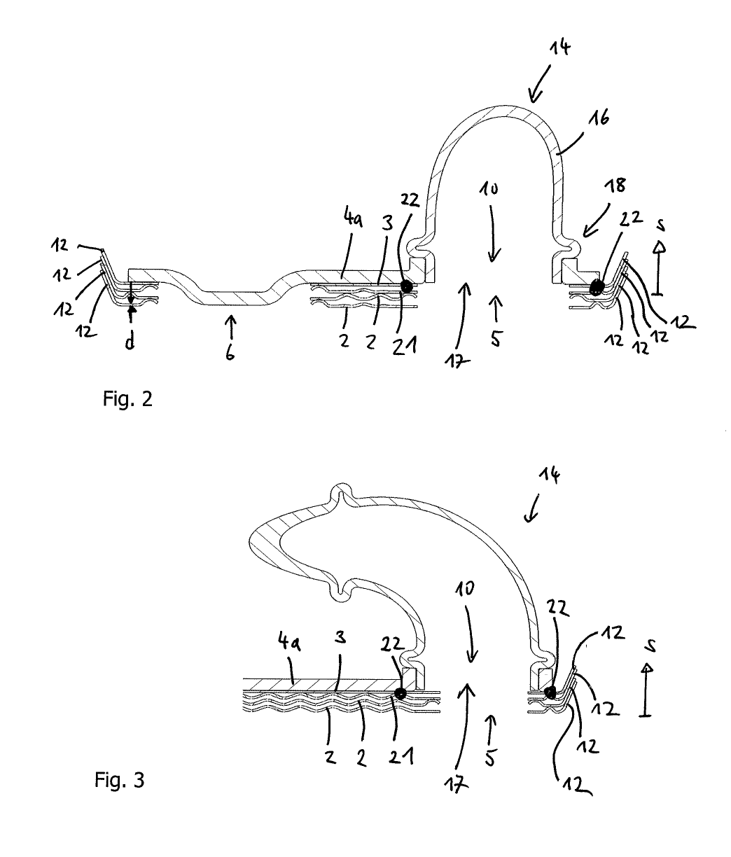

FIG. 2 shows the stacked heat exchanger 1 of FIG. 1 in a longitudinal section in the stacking direction S. As can be seen from FIG. 1 in combination with FIG. 2, the first end plate 4a has through-openings 10, which align with through-openings 5, 6 of the first stacked plate 3 with respect to the stacking direction S. The first stacked plate 3 according to FIG. 2 bears flat against the first end plate 4a in the region of the through-openings 5, 6 thereof.

The stacked plates 2 are soldered to each other in the region of the upright lips 12 thereof. The first stacked plate 3 and the second stacked plate 21 are connected to the first end plate 4a by means of a soldered connection in FIG. 2; another suitable integral connection 22 is also conceivable in variants of the example. The integral connection 22 according to the invention is particularly preferably arranged in the region of the through-openings 10 of the first end plate 4a and surrounds same.

At least one through-opening 5, 6 of at least one stacked plate 2 is in the form of a rim hole 11; this expressly does not apply to the first stacked plate 3. The through-openings 5, 6 of the flat first stacked plate 3 are not in the form of rim holes. As can be seen in FIG. 1, the through-openings 5, 6 of the stacked plates 2 are each formed alternately with and without a rim hole 11 in the stacking direction S in the example of FIGS. 1 and 2. In this manner, the first fluid F₁ can be distributed via the through-openings 5 to the first fluid channels 9a and collected again from same. Analogously, the second fluid F₂ can be distributed via the through-openings 6 to the second fluid channels 9a and collected again from same, in a fluidically separate manner from the first fluid F₁.

As can be seen in FIG. 2, the through-openings 5, 6 of the first stacked plate 3 have a greater opening cross section in the longitudinal section in the stacking direction S than the through-openings 10 of the first end plate 4a that are adjacent in the stacking direction S. In contrast, FIG. 3 shows an alternative variant to FIG. 2, in which the through-openings 5, 6 of the first stacked plate 3 have a smaller opening cross section in a longitudinal section in the stacking direction S than the through-openings 10 of the first end plate 4a that are adjacent in the stacking direction. In both variants, it is not necessary to solder the first end plate 4a to the lip 12 of the first stacked plate 3.

As can also be seen in FIGS. 2 and 3, the first end plate 4a can have an opening collar 13, which surrounds one of the through-openings 10 of the first end plate 4a and protrudes away from the first stacked plate 3 in the stacking direction S. Furthermore, the stacked-plate heat exchanger 1 has a connection piece 14. An end section 15 of the connection piece 14 is inserted into said through-opening 10 present in the first end plate 4a. As shown in FIGS. 2 and 3, the connection piece 14 can terminate flush with the first end plate 4a in the stacking direction S.

The connection piece 14 can furthermore be tubular and have a circumferential wall 16 with an end opening 17, which communicates fluidically with the through-opening 10 of the first end plate 4a.

As shown in FIGS. 2 and 3, an outwardly projecting bead 18 can be formed in the circumferential wall 16 of the connection piece 14 at a distance from the end opening 17 thereof. Said bead 18 bears against the opening collar 13 of the through-opening 10 of the first end plate 4a and in this manner ensures stable fixing of the connection piece 14 to the first end plate.

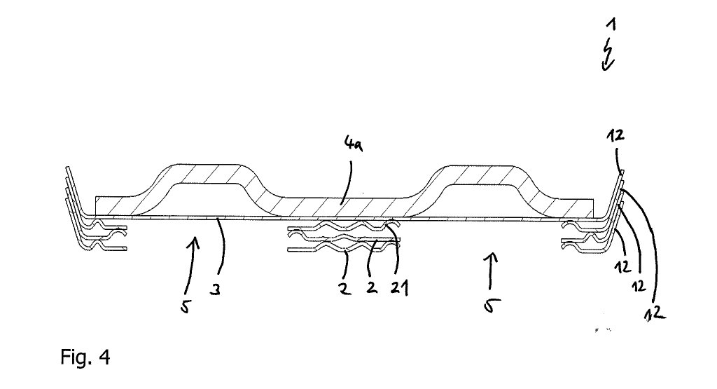

FIG. 4 shows a variant of the stacked heat exchanger 1 of FIGS. 1 to 3. In the example of FIG. 4, the through-openings 5 of the second stacked plate 21 are closed by the first stacked plate 3.

1. A stacked-plate heat exchanger, comprising:
a plurality of stacked plates that are stacked one on top of another in a stacking direction to form a first fluid channel and a second fluid channel through which a first fluid and a second fluid are flowable;
wherein the plurality of stacked plates are arranged in the stacking direction between a first end plate and a second end plate opposite the first end plate;
wherein the plurality of stacked plates have a plurality of through-openings that form distribution channels and collection channels;
wherein a first stacked plate of the plurality of stacked plates adjacent to the first end plate in the stacking direction is flat in at least a region of the plurality of through-openings of the first stacked plate;
wherein the first stacked plate is arranged in the stacking direction between the first end plate and a second stacked plate of the plurality of stacked plates, and the second stacked plate is connected to the first end plate and to the first stacked plate by an integral connection; and
wherein the integral connection is a soldered connection.

2. The stacked-plate heat exchanger according to claim 1, wherein the integral connection is arranged in a region of at least one of a plurality of through-openings of the first end plate.

3. The stacked-plate heat exchanger according to claim 1 wherein at least one of the plurality of through-openings of at least one of the plurality of stacked plates is in the form of a rim hole.

4. The stacked-plate heat exchanger according to claim 1, wherein the plurality of stacked plates have an upright lip running at least partially around the plurality of stacked plates.

5. The stacked-plate heat exchanger according to claim 4, wherein the first end plate does not have an upright lip.

6. The stacked-plate heat exchanger according to claim 4, wherein the first stacked plate is completely flat except for the upright lip.

7. The stacked-plate heat exchanger according to claim 1, wherein the first end plate has a plurality of through-openings that align with the plurality of through-openings of the first stacked plate with respect to the stacking direction.

8. The stacked-plate heat exchanger according to claim 1, wherein the first stacked plate bears flat against the first end plate in the region of the plurality of through-openings thereof.

9. The stacked-plate heat exchanger according to claim 1, wherein the plurality of stacked plates and the first stacked plate have a stacked plate thickness that is substantially the same.

10. The stacked-plate heat exchanger according to claim 3, wherein none of the plurality of through-openings of the first stacked plate are in the form of rim holes.

11. The stacked-plate heat exchanger according to claim 1, wherein the second stacked plate is arranged adjacently to the first stacked plate in the stacking direction, and at least one of the plurality of through-openings formed in the second stacked plate is closed by the first stacked plate.

12. The stacked-plate heat exchanger according to claim 1, wherein the first end plate has at least one opening collar that surrounds at least one of the plurality of through-openings of the first end plate and protrudes away from the first stacked plate in the stacking direction.

13. The stacked-plate heat exchanger according to claim 1, further comprising at least one connection piece, wherein the at least one connection piece has an end section that is inserted into at least one of a plurality of through-openings of the first end plate.

14. The stacked-plate heat exchanger according to claim 13, wherein:
the at least one connection piece has a circumferential wall with an end opening, the at least one connection piece being in fluid communication with at least one of the plurality of through-openings of the first end plate;
the first end plate has at least one opening collar that surrounds at least one of the plurality of through-openings of the first end plate and protrudes away from the first stacked plate in the stacking direction; and
an outwardly protruding bead formed in the circumferential wall at a distance from the end opening of the at least one connection piece, the bead bearing against the at least one opening collar.

15. The stacked-plate heat exchanger according to claim 1, wherein turbulence-generating elements are formed in at least one of the plurality of stacked plates.

16. The stacked-plate heat exchanger according to claim 15, wherein the turbulence-generating elements are fin-like structures.

17. A motor vehicle comprising a stacked-plate heat exchanger having:
a plurality of stacked plates that are stacked one on top of another in a stacking direction to form a first fluid channel and a second fluid channel through which a first fluid and a second fluid are flowable;
wherein the plurality of stacked plates are arranged in the stacking direction between a first end plate and a second end plate opposite the first end plate;
wherein the first end plate and the plurality of stacked plates have a plurality of through-openings that form distribution channels and collection channels;
wherein a first stacked plate of the plurality of stacked plates adjacent to the first end plate in the stacking direction is flat in at least a region of the plurality of through-openings of the first stacked plate;
wherein the first stacked plate is arranged in the stacking direction between the first end plate and a second stacked plate of the plurality of stacked plates, and the second stacked plate is connected to the first end plate and to the first stacked plate by an integral connection; and
wherein the integral connection is a soldered connection.

18. The stacked-plate heat exchanger according to claim 17, wherein the plurality of stacked plates have an upright lip running at least part way around the plurality of stacked plates.

19. The stacked-plate heat exchanger according to claim 17, wherein at least one of the plurality of through-openings of at least one of the plurality of stacked plates is in the form of a rim hole.

20. A motor vehicle having a stacked-plate heat, comprising:
a plurality of stacked plates that are stacked one on top of another in a stacking direction to form a first fluid channel and a second fluid channel through which a first fluid and a second fluid are flowable;
wherein the plurality of stacked plates are arranged in the stacking direction between a first end plate and a second end plate opposite the first end plate;
wherein the first end plate and the plurality of stacked plates have a plurality of through-openings, that form distribution channels and collection channels;
wherein the plurality of through-openings of the first end plate align with the plurality of through-openings of the first stacked plate with respect to the stacking direction;
wherein a first stacked plate of the plurality of stacked plates is adjacent to the first end plate in the stacking direction and bears flat against the first end plate in the region of the plurality of through-openings thereof;
wherein the first stacked plate is flat, at least in the region of the plurality of through-openings of the first stacked plate;
wherein the first stacked plate is arranged in the stacking direction between the first end plate and a second stacked plate of the plurality of stacked plates, and the second stacked plate is connected to the first end plate and to the first stacked plate by an integral connection; and
wherein the integral connection is a soldered connection.
